(19) United States
(12) Patent Application Publication
(10) Pub. No.: US 2025/0071603 A1
(43) Pub. Date: Feb. 27, 2025

(54) SYSTEMS AND METHODS FOR APPLYING QUALITY OF SERVICE PROFILES BASED ON OBSERVED FLOW DATA RATES

(71) Applicant: Verizon Patent and Licensing Inc., Basking Ridge, NJ (US)

(72) Inventors: Violeta CAKULEV, Milburn, NJ (US); Lixia YAN, Basking Ridge, NJ (US); Sudhakar Reddy PATIL, Flower Mound, TX (US); Lily ZHU, Parsippany, NJ (US); Raquel MORERA SEMPERE, Weehawken, NJ (US); Samirkumar PATEL, Middlesex, NJ (US); Cindy Yuexin DONG, Bridgewater, NJ (US); Vijayakrishna P. GUDURU, Denville, NJ (US)

(73) Assignee: Verizon Patent and Licensing Inc., Basking Ridge, NJ (US)

(21) Appl. No.: 18/452,921

(22) Filed: Aug. 21, 2023

(51) Int. Cl. H04W 28/02

(52) U.S. Cl. CPC H04W 28/0268; H04W 28/0226; H04W 28/0236

(57) ABSTRACT

In some implementations, a radio access network (RAN) may receive a graded quality of service (QoS) profile indicating a set of QoS profiles and corresponding observed flow data rates. The RAN may measure an observed flow data rate of traffic associated with a session. The RAN may select a QoS profile from the set of QoS profiles based on the observed flow data rate. The RAN may apply the QoS profile to the session.

### BACKGROUND

Wireless communication systems are widely deployed to provide various telecommunication services such as telephony, video, data, messaging, and broadcasts. A wireless network may include one or more network nodes that support communication for wireless communication devices, such as a user equipment (UE). A UE may communicate with a network node via downlink communications and uplink communications.

### BRIEF DESCRIPTION OF THE DRAWINGS

FIG. 1 is a diagram of an example associated with applying quality of service (QoS) profiles based on observed flow data rates.

FIG. 2 is a diagram of an example associated with applying QoS profiles based on observed flow data rates.

FIG. 3 is a diagram of an example environment in which systems and/or methods described herein may be implemented.

FIG. 4 is a diagram of example components of one or more devices of FIG. 3.

FIG. 5 is a flowchart of an example process associated with applying QoS profiles based on observed flow data rates.

### DETAILED DESCRIPTION OF EXAMPLE EMBODIMENTS

The following detailed description of example implementations refers to the accompanying drawings. The same reference numbers in different drawings may identify the same or similar elements.

A Third Generation Partnership Project (3GPP) specification may define a Fifth Generation (5G) quality of service (QoS) model, which may be based on a QoS flow. The 5G QoS model may support a guaranteed bit rate (GBR) QoS flow, which may be a QoS flow that requires a guaranteed flow bit rate. The 5G QoS model may also support a non-GBR QoS flow, which may be a QoS flow that does not require a guaranteed flow bit rate. The QoS flow may be the GBR QoS flow or the non-GBR QoS flow depending on its QoS profile. In other words, the QoS profile associated with the QoS flow may indicate whether the QoS flow is the GBR QoS flow or the non-GBR QoS flow. The QoS profile of the QoS flow may be provided to a radio access network (RAN). The QoS profile may indicate various QoS parameters, such as a 5G QoS identifier (5Q1), an allocation and retention priority (ARP), a guaranteed flow bit rate (GFBR), and/or a maximum flow bit rate (MFBR).

The 3GPP specification may also define an alternative QoS profile. The alternative QoS profile may be optionally provided for the GBR QoS flow with a notification control enabled. The alternative QoS profile may represent a combination of QoS parameters, such as a packet delay budget (PDB), a packet error rate (PER), and/or the GFBR. Application traffic may be able to adapt to one or more QoS parameters indicated in the alternative QoS profile.

A core network, such as a session management function (SMF) in the core network, may provide the alternative QoS profile (or a prioritized list of alternative QoS profiles) to the RAN, such as a Next Generation (NG) RAN (NG-RAN). The core network may provide the alternative QoS profile in addition to the QoS profile. The core network may provide the alternative QoS profile based on a corresponding policy charging and control (PCC) rule indicating related information. When the core network (e.g., the SMF) provides a new alternative QoS profile to the RAN (e.g., based on a change to corresponding PCC rule information), the RAN may replace a previous alternative QoS profile with the new alternative QoS profile.

However, neither the QoS profile nor the alternative QoS profile provide a function in which a core network is able to indicate, to the RAN, a QoS profile to be applied based on flow data rates observed in a wireless network. The QoS profile may not be based on the flow data rates observed in the wireless network. As a result, the QoS profile that is applied may not necessarily be suitable for actual real-time conditions associated with the wireless network, and thereby, the QoS profile that is applied may actually degrade a performance associated with the wireless network.

In some implementations, a RAN (or a node associated with the RAN) may receive, from a core network, a graded QoS profile. The graded QoS profile may indicate a set of QoS profiles and corresponding observed flow data rates. For example, within the graded QoS profile, a first QoS profile may be associated with a first observed flow data rate (or a first range of observed flow data rates), a second QoS profile may be associated with a second observed flow data rate (or a second range of observed flow data rates), and so on. The RAN may measure an observed flow data rate of traffic associated with a session. The RAN may measure the observed flow data rate of traffic itself. Alternatively or additionally, the RAN may receive information associated with a measured data rate from a network function, such as a network data analytics function (NWDAF). The RAN may determine which QoS profile, from the graded QoS profile, is associated with the observed flow data rate of traffic associated with the session. The RAN may select the QoS profile from the set of QoS profiles based on the observed flow data rate. The RAN may apply the QoS profile to the session.

In some implementations, the core network may indicate, to the RAN, the graded QoS profile, which may indicate which QoS profile is to be applied depending on the observed flow data rate. The observed flow data rate may be representative of an actual flow data rate. The core network may instruct the RAN, via the graded QoS profile, to apply different tiers of low latency service level agreements (SLAs) based on the observed flow data rate. For example, the core network may instruct the RAN to apply a low throughput low latency QoS (e.g., 5QI 133 and a downlink/uplink (DL/UL) session aggregate maximum bit rate (AMBR) of 20/10 megabits per second (Mbps)) for an observed DL/UL rate of 10/2 Mbps (e.g., 10 Mbps in a downlink direction and 2 Mbps in an uplink direction). The core network may instruct the RAN to apply a high throughput low latency QoS (e.g., 5QI 133 and a DL/UL session AMBR of 60/60 Mbps) for an observed DL/UL rate of 50/10 Mbps (e.g., 50 Mbps in a downlink direction and 10 Mbps in an uplink direction). The core network may instruct the RAN to apply no low latency QoS (e.g., 5QI 8 and a DL/UL session AMBR of 100/100 Mbps) for an observed DL/UL rate that is beyond 50/10 Mbps (e.g., 50 Mbps in a downlink direction and 10 Mbps in an uplink direction).

In some implementations, the graded QoS may provide a functionality in which the core network may indicate to the RAN which QoS profile to apply based on the observed flow data rate in a wireless network. The RAN may measure the observed flow data rate, and then apply an appropriate QoS profile based on the observed flow data rate. As a result, the QoS profile applied by the RAN may be based on an actual flow data rate associated with the session, instead of a predefined flow data rate (e.g., a non-observed flow data rate). By applying the QoS profile that is based on the observed flow data rate, the RAN may be able to apply different tiers of low latency SLAs (e.g., low throughput low latency QoS, high throughput low latency QoS, or no low latency QoS), which may improve an overall system performance.

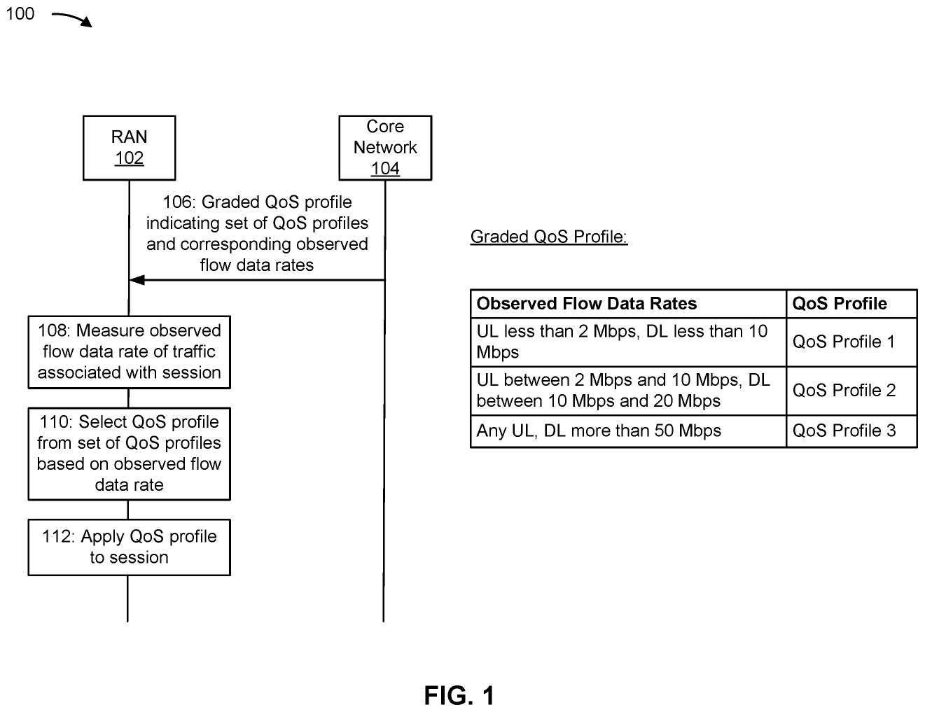

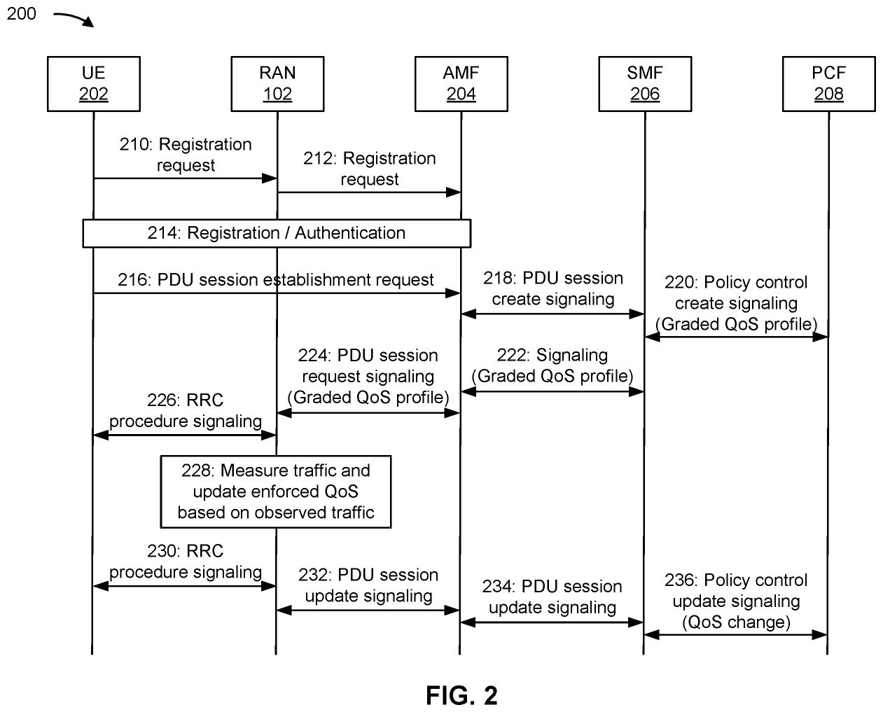

FIG. 1 is a diagram of an example 100 associated with applying QoS profiles based on observed flow data rates. As shown in FIG. 1, example 100 includes a RAN 102 (or a node in the RAN 102, such as a base station) and a core network 104. The core network 104 may include an access and mobility management function (AMF), an SMF, and/or a policy control function (PCF), as shown in FIG. 2.

As shown by reference number 106, the RAN 102 (or the node in the RAN 102) may receive, from the core network 104, a graded QoS profile. The RAN 102 may receive the graded QoS profile from the PCF 208 via the AMF 204 and/or the SMF 206. The RAN 102 may receive the graded QoS profile during a session management establishment procedure.

In some implementations, the graded QoS profile may indicate a set of QoS profiles and corresponding observed flow data rates. The set of QoS profiles may be enforced in the RAN 102 based on flow data rates observed in the RAN 102. The corresponding observed flow data rates may be associated with uplink data rates and/or downlink data rates. The corresponding observed flow data rates may include specific flow data rates and/or ranges of flow data rates. In other words, the graded QoS profile may include a number of observed flow data rates and the applicable QoS profile for each observed flow data rate, where the observed flow data rates may be applicable to uplink traffic and/or downlink traffic, or different observed flow data rates may be applicable for uplink traffic versus downlink traffic. Each individual QoS profile in the graded QoS profile may indicate various parameters, such as a 5QI, an ARP, and/or a session bit rate.

As an example, as shown in FIG. 1, the graded QoS profile may indicate that a first QoS profile is associated with observed flow data rates of less than 2 Mbps for an uplink direction and less than 10 Mbps for a downlink direction. The first QoS profile may be associated with a first set of parameters (e.g., 5QI, ARP, and/or session bit rate). The graded QoS profile may indicate that a second QoS profile is associated with observed flow data rates of between 2 Mbps and 10 Mbps for an uplink direction and between 10 Mbps and 20 Mbps for a downlink direction. The second QoS profile may be associated with a second set of parameters. The graded QoS profile may indicate that a third QoS profile is associated with observed flow data rates of any value for an uplink direction and more than 50 Mbps for a downlink direction. The third QoS profile may be associated with a third set of parameters.

As shown by reference number 108, the RAN 102 (or the node in the RAN 102) may measure an observed flow data rate of traffic associated with a session. Alternatively or additionally, the RAN 102 may receive information associated with a measured data rate from a network function, such as an NWDAF. The RAN 102 may measure the observed flow data rate of downlink traffic associated with the session. The RAN 102 may measure the observed flow data rate of uplink traffic associated with the session. The observed flow data rate may be an actual flow data rate associated with the session. The RAN 102 may measure the observed flow data rate of traffic in terms of Mbps.

As shown by reference number 110, the RAN 102 (or the node in the RAN 102) may select a QoS profile from the set of QoS profiles based on the observed flow data rate. The RAN 102 may select the QoS profile, from the set of QoS profiles, that is associated with the observed flow data rate. The QoS profile may be associated with a certain flow data rate or a range of flow data rates, and the observed flow data rate may correspond to the certain flow data rate or the range of flow data rates.

As an example, when the observed flow data rate is 1 Mbps in the uplink direction and/or 5 Mbps in the downlink direction, the RAN 102 may select the first QoS profile from the set of QoS profiles. As another example, when the observed flow data rate is 8 Mbps in the uplink direction and/or 16 Mbps in the downlink direction, the RAN 102 may select the second QoS profile from the set of QoS profiles. As yet another example, when the observed flow data rate is 20 Mbps in the uplink direction and/or 60 Mbps in the downlink direction, the RAN 102 may select the third QoS profile from the set of QoS profiles.

As shown by reference number 112, the RAN 102 (or the node in the RAN 102) may apply the QoS profile to the session. The RAN 102 may enforce the QoS profile for traffic associated with the session, where the traffic may be uplink traffic and/or downlink traffic. For example, based on the QoS profile applied to traffic associated with the session, the RAN 102 may apply different tiers of low latency SLAs. The RAN 102 may transmit, to the core network 104, an indication of the QoS profile applied to the session.

As indicated above, FIG. 1 is provided as an example. Other examples may differ from what is described with regard to FIG. 1. The number and arrangement of devices shown in FIG. 1 are provided as an example. In practice, there may be additional devices, fewer devices, different devices, or differently arranged devices than those shown in FIG. 1. Furthermore, two or more devices shown in FIG. 1 may be implemented within a single device, or a single device shown in FIG. 1 may be implemented as multiple, distributed devices. Additionally, or alternatively, a set of devices (e.g., one or more devices) shown in FIG. 1 may perform one or more functions described as being performed by another set of devices shown in FIG. 1.

In some implementations, the graded QoS may provide a functionality in which the core network 104 may indicate to the RAN 102 which QoS profile to apply based on the observed flow data rate in a wireless network. The RAN 102 may measure the observed flow data rate, and then apply an appropriate QoS profile based on the observed flow data rate. As a result, the QoS profile applied by the RAN may be based on an actual flow data rate associated with the session, instead of a predefined flow data rate (e.g., a non-observed flow data rate). By applying the QoS profile that is based on the observed flow data rate, the RAN may be able to apply the different tiers of low latency SLAs (e.g., low throughput low latency QoS, high throughput low latency QoS, or no low latency QoS), which may improve an overall system performance.

FIG. 2 is a diagram of an example 200 associated with applying QoS profiles based on observed flow data rates. As shown in FIG. 2, example 200 includes a UE 202, a RAN 102 (or a node in the RAN 102), an AMF 204, an SMF 206, and a PCF 208.

As shown by reference number 210, during a session management establishment procedure, the UE 202 may transmit a registration request to the RAN 102. As shown by reference number 212, the RAN 102 may forward the registration request to the AMF 204. As shown by reference number 214, the UE 202 and the AMF 204 may perform a registration and authentication procedure via the RAN 102. As shown by reference number 216, the UE 202 may transmit a packet data unit (PDU) session establishment request to the AMF 204. As shown by reference number 218, the AMF 204 and the SMF 206 may exchange a PDU session create signaling (e.g., Nsmf_PDUSession_Create). As shown by reference number 220, the SMF 206 and the PCF 208 may exchange policy control create signaling (e.g., Npcf_SMPolicy Control_Create). The policy control create signaling may indicate a graded QoS profile. The graded QoS profile may indicate a number of observed flow data rates and an applicable QoS profile for each observed flow data rate. During the session management establishment procedure, the PCF 208 may determine that a session requires a graded QoS, and the PCF 208 may include the graded QoS profile in signaling provided to the SMF 206.

As shown by reference number 222, the AMF 204 and the SMF 206 may exchange signaling (e.g., Namf_Communication, which may include an N1N2MessageTransfer). The signaling may indicate the graded QoS profile. As shown by reference number 224, the RAN 102 and the AMF 204 may exchange a PDU session request signaling (e.g., an N2 PDU session request). The PDU session request signaling may indicate the graded QoS profile. The graded QoS profile may be propagated to the RAN 102 via the AMF 204. As shown by reference number 226, the UE 202 and the RAN 102 may exchange a radio resource control (RRC) procedure signaling.

As shown by reference number 228, the RAN 102 may measure traffic and update an enforced QoS profile based on observed traffic. The RAN 102 may determine an observed flow data rate of traffic associated with the session. Depending on the observed flow data rate, the RAN 102 may select a certain QoS profile from the graded QoS profile. The RAN 102 may apply the QoS profile selected from the graded QoS profile to the session. In other words, the RAN 102 may measure traffic rates for the session, and based on observed traffic rates, the RAN 102 may apply QoS profiles applicable to the observed traffic rates.

As shown by reference number 230, the UE 202 and the RAN 102 may exchange an RRC procedure signaling. As shown by reference number 232, the RAN 102 and the AMF 204 may exchange a PDU session update signaling (e.g., N2 PDU Session Update). As shown by reference number 234, the AMF 204 and the SMF 206 may exchange a PDU session update signaling (e.g., Nsmf_PDUSession Update). As shown by reference number 236, the SMF 206 and the PCF 208 may exchange a policy control update signaling (e.g., Npcf_SMPolicy Control_Update), which may indicate a QoS change (e.g., the QoS profile selected from the graded QoS profile). As a result, the PCF 208 may be notified of the QoS profile selected and applied by the RAN 102. The PCF 208 may be updated with a currently enforced QoS profile.

In some implementations, PCF/RAN enhancements may be needed for the PCF 208 to communicate the graded QoS profile to the RAN 102, and for the RAN 102 to apply different QoS profiles based on the provided graded QoS profile and based on observed traffic rates. The PCF/RAN enhancements may enable a graded QoS functionality to be implemented by the RAN 102. Further, PCF enhancements may be needed to determine that the graded QoS profile is needed for the session, determine the graded QoS profile itself, and then communicate the graded QoS profile.

As indicated above, FIG. 2 is provided as an example. Other examples may differ from what is described with regard to FIG. 2.

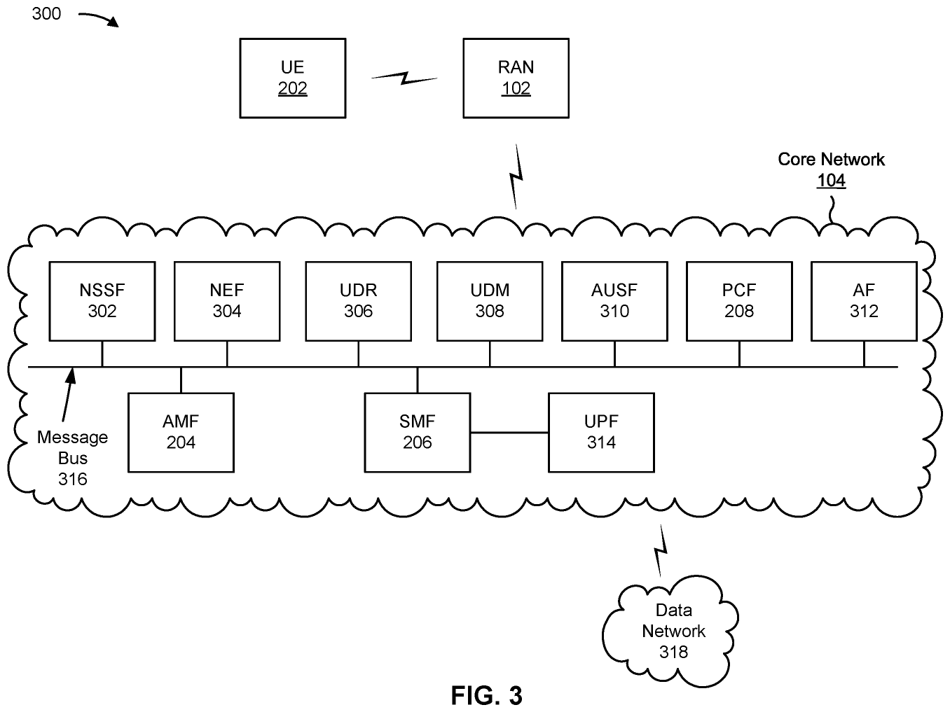

FIG. 3 is a diagram of an example environment 300 in which systems and/or methods described herein may be implemented. As shown in FIG. 3, example environment 300 may include a UE 202, a RAN 102 (or a node in the RAN 102), a core network 104, and/or a data network 318. Devices and/or networks of example environment 300 may interconnect via wired connections, wireless connections, or a combination of wired and wireless connections.

The UE 202 may include one or more devices capable of receiving, generating, storing, processing, and/or providing information, such as information described herein. For example, The UE 202 can include a mobile phone (e.g., a smart phone or a radiotelephone), a laptop computer, a tablet computer, a desktop computer, a handheld computer, a gaming device, a wearable communication device (e.g., a smart watch or a pair of smart glasses), a mobile hotspot device, a fixed wireless access device, customer premises equipment, an autonomous vehicle, or a similar type of device.

The RAN 102 may support, for example, a cellular radio access technology (RAT). The RAN 102 may include one or more base stations (e.g., base transceiver stations, radio base stations, node Bs, eNodeBs (eNBs), gNodeBs (gNBs), base station subsystems, cellular sites, cellular towers, access points, transmit receive points (TRPs), radio access nodes, macrocell base stations, microcell base stations, picocell base stations, femtocell base stations, or similar types of devices) and other network entities that can support wireless communication for the UE 202. The RAN 102 may transfer traffic between the UE 202 (e.g., using a cellular RAT), one or more base stations (e.g., using a wireless interface or a backhaul interface, such as a wired backhaul interface), and/or the core network 104. The RAN 102 may provide one or more cells that cover geographic areas. A base station may be an aggregated network node, meaning that the base station is configured to utilize a radio protocol stack that is physically or logically integrated within a single RAN node (e.g., within a single device or unit). Alternatively, the base station may be a disaggregated base station, meaning that the base station is configured to utilize a protocol stack that is physically or logically distributed among two or more nodes (such as one or more central units (CUs), one or more distributed units (DUs), or one or more radio units (RUs)). The base station may include, for example, a New Radio (NR) base station, a Long Term Evolution (LTE) base station, a Node B, an eNB (e.g., in 4G), a gNB (e.g., in 5G), an access point, a TRP, a DU, an RU, a CU, a mobility element of a network, a core network node, a network element, a network equipment, and/or a RAN node.

The RAN 102 may perform scheduling and/or resource management for the UE 202 covered by the RAN 102 (e.g., the UE 202 covered by a cell provided by the RAN 102). The RAN 102 may be controlled or coordinated by a network controller, which may perform load balancing, network-level configuration, and/or other operations. The network controller may communicate with the RAN 102 via a wireless or wireline backhaul. The RAN 102 may include a network controller, a self-organizing network (SON) module or component, or a similar module or component. In other words, the RAN 102 may perform network control, scheduling, and/or network management functions (e.g., for uplink, downlink, and/or sidelink communications of the UE 202 covered by the RAN 102).

The core network 104 may include an example functional architecture in which systems and/or methods described herein may be implemented. For example, the core network 104 may include an example architecture of a 5G NG core network included in a 5G wireless telecommunications system. The core network 104 may be based on a service-based architecture. Alternatively, the core network 104 may be implemented as a reference-point architecture and/or a 4G core network, among other examples.

The core network 104 include a number of functional elements. The functional elements may include, for example, a network slice selection function (NSSF) 302, a network exposure function (NEF) 304, a unified data repository (UDR) 306, a unified data management (UDM) 308, an authentication server function (AUSF) 310, a PCF 208, an application function (AF) 312, an AMF 204, an SMF 206, and/or a user plane function (UPF) 314. These functional elements may be communicatively connected via a message bus 316. Each of the functional elements shown in FIG. 3 is implemented on one or more devices associated with a wireless telecommunications system. In some implementations, one or more of the functional elements may be implemented on physical devices, such as an access point, a base station, and/or a gateway. In some implementations, one or more of the functional elements may be implemented on a computing device of a cloud computing environment.

The NSSF 302 may include one or more devices that select network slice instances for the UE 202. By providing network slicing, the NSSF 302 may allow an operator to deploy multiple substantially independent end-to-end networks potentially with the same infrastructure. In some implementations, each slice may be customized for different services. The NEF 304 may include one or more devices that support exposure of capabilities and/or events in the wireless telecommunications system to help other entities in the wireless telecommunications system discover network services.

The UDR 306 may include one or more devices that provide a converged repository, which may be used by network functions to store data. For example, a converged repository of subscriber information may be used to service a number of network functions. The UDM 308 may include one or more devices to store user data and profiles in the wireless telecommunications system. The UDM 308 may generate authentication vectors, perform user identification handling, perform subscription management, and perform other various functions. The UDM 308 may be used for fixed access and/or mobile access in the core network 104. The AUSF 310 may include one or more devices that act as an authentication server and support the process of authenticating the UE 202 in the wireless telecommunications system.

The PCF 208 may include one or more devices that provide a policy framework that incorporates network slicing, roaming, packet processing, and/or mobility management, among other examples. The AF 312 may include one or more devices that support application influence on traffic routing, access to the NEF 304, and/or policy control, among other examples. The AMF 204 may include one or more devices that act as a termination point for non-access stratum (NAS) signaling and/or mobility management, among other examples. The SMF 206 may include one or more devices that support the establishment, modification, and release of communication sessions in the wireless telecommunications system. For example, the SMF 206 may configure traffic steering policies at the UPF 314 and/or may enforce UE Internet Protocol (IP) address allocation and policies, among other examples. The UPF 314 may include one or more devices that serve as an anchor point for intra-RAT and/or inter-RAT mobility. The UPF 314 may apply rules to packets, such as rules pertaining to packet routing, traffic reporting, and/or handling user plane QoS, among other examples. The message bus 316 may represent a communication structure for communication among the functional elements. In other words, the message bus 316 may permit communication between two or more functional elements.

The data network 318 may include one or more wired and/or wireless data networks. For example, the data network 318 may include an IP multimedia subsystem (IMS), a public land mobile network (PLMN), a local area network (LAN), a wide area network (WAN), a metropolitan area network (MAN), a private network such as a corporate intranet, an ad hoc network, the Internet, a fiber optic-based network, a cloud computing network, a third party services network, an operator services network, and/or a combination of these or other types of networks.

The number and arrangement of devices and networks shown in FIG. 3 are provided as an example. In practice, there may be additional devices and/or networks, fewer devices and/or networks, different devices and/or networks, or differently arranged devices and/or networks than those shown in FIG. 3. Furthermore, two or more devices shown in FIG. 3 may be implemented within a single device, or a single device shown in FIG. 3 may be implemented as multiple, distributed devices. Additionally, or alternatively, a set of devices (e.g., one or more devices) of example environment 300 may perform one or more functions described as being performed by another set of devices of example environment 300.

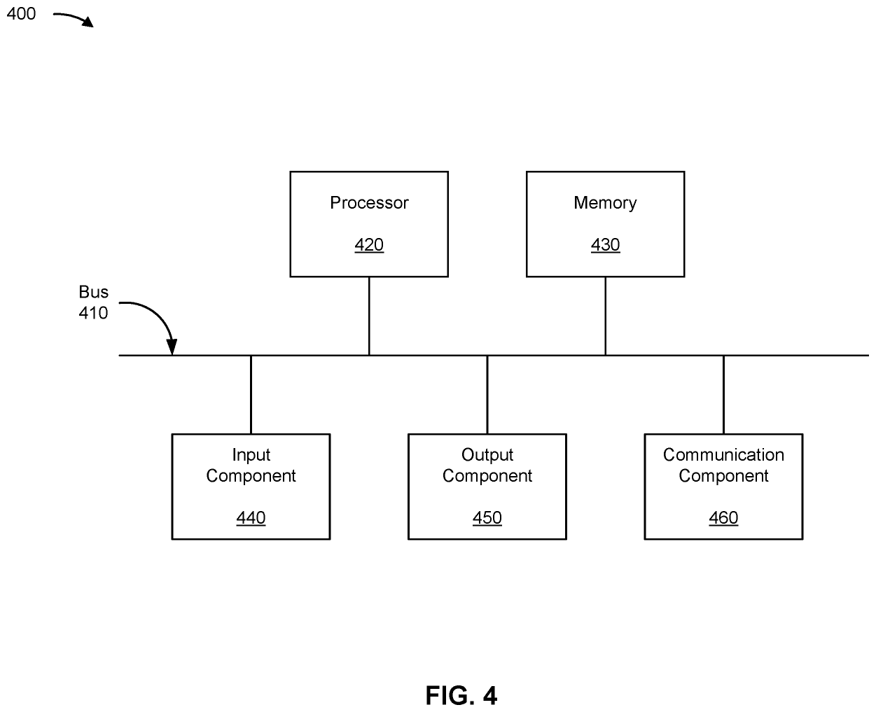

FIG. 4 is a diagram of example components of a device 400 associated with applying QoS profiles based on observed flow data rates. The device 400 may correspond to a RAN (e.g., RAN 102) (or a node in the RAN 102). In some implementations, the RAN may include one or more devices 400 and/or one or more components of the device 400. As shown in FIG. 4, the device 400 may include a bus 410, a processor 420, a memory 430, an input component 440, an output component 450, and/or a communication component 460.

The bus 410 may include one or more components that enable wired and/or wireless communication among the components of the device 400. The bus 410 may couple together two or more components of FIG. 4, such as via operative coupling, communicative coupling, electronic coupling, and/or electric coupling. For example, the bus 410 may include an electrical connection (e.g., a wire, a trace, and/or a lead) and/or a wireless bus. The processor 420 may include a central processing unit, a graphics processing unit, a microprocessor, a controller, a microcontroller, a digital signal processor, a field-programmable gate array, an application-specific integrated circuit, and/or another type of processing component. The processor 420 may be implemented in hardware, firmware, or a combination of hardware and software. In some implementations, the processor 420 may include one or more processors capable of being programmed to perform one or more operations or processes described elsewhere herein.

The memory 430 may include volatile and/or nonvolatile memory. For example, the memory 430 may include random access memory (RAM), read only memory (ROM), a hard disk drive, and/or another type of memory (e.g., a flash memory, a magnetic memory, and/or an optical memory). The memory 430 may include internal memory (e.g., RAM, ROM, or a hard disk drive) and/or removable memory (e.g., removable via a universal serial bus connection). The memory 430 may be a non-transitory computer-readable medium. The memory 430 may store information, one or more instructions, and/or software (e.g., one or more software applications) related to the operation of the device 400. In some implementations, the memory 430 may include one or more memories that are coupled (e.g., communicatively coupled) to one or more processors (e.g., processor 420), such as via the bus 410. Communicative coupling between a processor 420 and a memory 430 may enable the processor 420 to read and/or process information stored in the memory 430 and/or to store information in the memory 430.

The input component 440 may enable the device 400 to receive input, such as user input and/or sensed input. For example, the input component 440 may include a touch screen, a keyboard, a keypad, a mouse, a button, a microphone, a switch, a sensor, a global positioning system sensor, a global navigation satellite system sensor, an accelerometer, a gyroscope, and/or an actuator. The output component 450 may enable the device 400 to provide output, such as via a display, a speaker, and/or a light-emitting diode. The communication component 460 may enable the device 400 to communicate with other devices via a wired connection and/or a wireless connection. For example, the communication component 460 may include a receiver, a transmitter, a transceiver, a modem, a network interface card, and/or an antenna.

The device 400 may perform one or more operations or processes described herein. For example, a non-transitory computer-readable medium (e.g., memory 430) may store a set of instructions (e.g., one or more instructions or code) for execution by the processor 420. The processor 420 may execute the set of instructions to perform one or more operations or processes described herein. In some implementations, execution of the set of instructions, by one or more processors 420, causes the one or more processors 420 and/or the device 400 to perform one or more operations or processes described herein. In some implementations, hardwired circuitry may be used instead of or in combination with the instructions to perform one or more operations or processes described herein. Additionally, or alternatively, the processor 420 may be configured to perform one or more operations or processes described herein. Thus, implementations described herein are not limited to any specific combination of hardware circuitry and software.

The number and arrangement of components shown in FIG. 4 are provided as an example. The device 400 may include additional components, fewer components, different components, or differently arranged components than those shown in FIG. 4. Additionally, or alternatively, a set of components (e.g., one or more components) of the device 400 may perform one or more functions described as being performed by another set of components of the device 400.

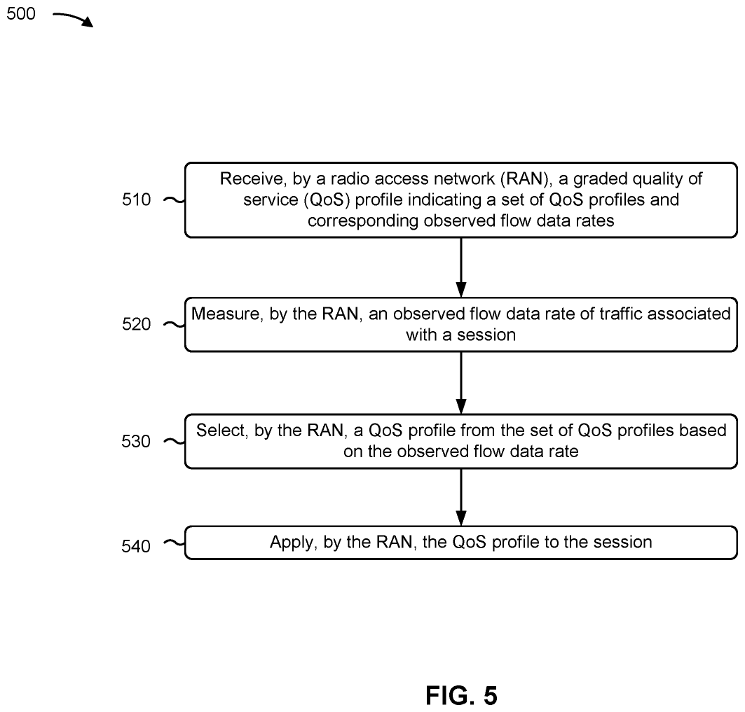

FIG. 5 is a flowchart of an example process 500 associated with applying QoS profiles based on observed flow data rates. In some implementations, one or more process blocks of FIG. 5 may be performed by a RAN (e.g., RAN 102) (or a node in the RAN). In some implementations, one or more process blocks of FIG. 5 may be performed by another device or a group of devices separate from or including the RAN, such as a UE (e.g., UE 202), an AMF (e.g., AMF 204), an SMF (e.g., SMF 206), and/or a PCF (e.g., PCF 208). Additionally, or alternatively, one or more process blocks of FIG. 5 may be performed by one or more components of device 400, such as processor 420, memory 430, input component 440, output component 450, and/or communication component 460.

As shown in FIG. 5, process 500 may include receiving, by the RAN, a graded QoS profile indicating a set of QoS profiles and corresponding observed flow data rates (block 510). The RAN may receive the graded QoS profile from a PCF via an AMF and/or an SMF. The RAN may receive the graded QoS profile during a session management establishment procedure. The set of QoS profiles may be enforced in the RAN based on flow data rates observed in the RAN. The corresponding observed flow data rates may be associated with one or more of uplink data rates or downlink data rates. The corresponding observed flow data rates may include one or more of specific flow data rates or ranges of flow data rates. The PCF may determine that the graded QoS profile is needed. The PCF may determine the graded QoS profile, and then send the graded QoS profile to the RAN.

As shown in FIG. 5, process 500 may include measuring, by the RAN, an observed flow data rate of traffic associated with a session (block 520). The RAN may measure the observed flow data rate of downlink traffic associated with the session. The RAN may measure the observed flow data rate of uplink traffic associated with the session. The observed flow data rate may be an actual flow data rate associated with the session.

As shown in FIG. 5, process 500 may include selecting, by the RAN, a QoS profile from the set of QoS profiles based on the observed flow data rate (block 530). The RAN may select the QoS profile, from the set of QoS profiles, that is associated with the observed flow data rate. The QoS profile may be associated with a certain flow data rate or a range of flow data rates, and the observed flow data rate may correspond to the certain flow data rate or the range of flow data rates.

As shown in FIG. 5, process 500 may include applying, by the RAN, the QoS profile to the session (block 540). The RAN may enforce the QoS profile for traffic associated with the session, where the traffic may be uplink traffic and/or downlink traffic. The RAN may transmit, to the PCF, an indication of the QoS profile applied to the session.

Although FIG. 5 shows example blocks of process 500, in some implementations, process 500 may include additional blocks, fewer blocks, different blocks, or differently arranged blocks than those depicted in FIG. 5. Additionally, or alternatively, two or more of the blocks of process 500 may be performed in parallel.

As used herein, the term “component” is intended to be broadly construed as hardware, firmware, or a combination of hardware and software. It will be apparent that systems and/or methods described herein may be implemented in different forms of hardware, firmware, and/or a combination of hardware and software. The actual specialized control hardware or software code used to implement these systems and/or methods is not limiting of the implementations. Thus, the operation and behavior of the systems and/or methods are described herein without reference to specific software code-it being understood that software and hardware can be used to implement the systems and/or methods based on the description herein.

As used herein, satisfying a threshold may, depending on the context, refer to a value being greater than the threshold, greater than or equal to the threshold, less than the threshold, less than or equal to the threshold, equal to the threshold, not equal to the threshold, or the like.

To the extent the aforementioned implementations collect, store, or employ personal information of individuals, it should be understood that such information shall be used in accordance with all applicable laws concerning protection of personal information. Additionally, the collection, storage, and use of such information can be subject to consent of the individual to such activity, for example, through well known “opt-in” or “opt-out” processes as can be appropriate for the situation and type of information. Storage and use of personal information can be in an appropriately secure manner reflective of the type of information, for example, through various encryption and anonymization techniques for particularly sensitive information.

Even though particular combinations of features are recited in the claims and/or disclosed in the specification, these combinations are not intended to limit the disclosure of various implementations. In fact, many of these features may be combined in ways not specifically recited in the claims and/or disclosed in the specification. Although each dependent claim listed below may directly depend on only one claim, the disclosure of various implementations includes each dependent claim in combination with every other claim in the claim set. As used herein, a phrase referring to “at least one of” a list of items refers to any combination of those items, including single members. As an example, “at least one of: a, b, or c” is intended to cover a, b, c, a-b, a-c, b-c, and a-b-c, as well as any combination with multiple of the same item.

When “a processor” or “one or more processors” (or another device or component, such as “a controller” or “one or more controllers”) is described or claimed (within a single claim or across multiple claims) as performing multiple operations or being configured to perform multiple operations, this language is intended to broadly cover a variety of processor architectures and environments. For example, unless explicitly claimed otherwise (e.g., via the use of “first processor” and “second processor” or other language that differentiates processors in the claims), this language is intended to cover a single processor performing or being configured to perform all of the operations, a group of processors collectively performing or being configured to perform all of the operations, a first processor performing or being configured to perform a first operation and a second processor performing or being configured to perform a second operation, or any combination of processors performing or being configured to perform the operations. For example, when a claim has the form “one or more processors configured to: perform X; perform Y; and perform Z,” that claim should be interpreted to mean “one or more processors configured to perform X; one or more (possibly different) processors configured to perform Y; and one or more (also possibly different) processors configured to perform Z.”

No element, act, or instruction used herein should be construed as critical or essential unless explicitly described as such. Also, as used herein, the articles “a” and “an” are intended to include one or more items, and may be used interchangeably with “one or more.” Further, as used herein, the article “the” is intended to include one or more items referenced in connection with the article “the” and may be used interchangeably with “the one or more.” Furthermore, as used herein, the term “set” is intended to include one or more items (e.g., related items, unrelated items, or a combination of related and unrelated items), and may be used interchangeably with “one or more.” Where only one item is intended, the phrase “only one” or similar language is used. Also, as used herein, the terms “has,” “have,” “having,” or the like are intended to be open-ended terms. Further, the phrase “based on” is intended to mean “based, at least in part, on” unless explicitly stated otherwise. Also, as used herein, the term “or” is intended to be inclusive when used in a series and may be used interchangeably with “and/or,” unless explicitly stated otherwise (e.g., if used in combination with “either” or “only one of”).

In the preceding specification, various example embodiments have been described with reference to the accompanying drawings. It will, however, be evident that various modifications and changes may be made thereto, and additional embodiments may be implemented, without departing from the broader scope of the invention as set forth in the claims that follow. The specification and drawings are accordingly to be regarded in an illustrative rather than restrictive sense.

What is claimed is:

1. A method, comprising:
receiving, by a radio access network (RAN), a graded quality of service (QoS) profile indicating a set of QoS profiles and corresponding observed flow data rates;
measuring, by the RAN, an observed flow data rate of traffic associated with a session;
selecting, by the RAN, a QoS profile from the set of QoS profiles based on the observed flow data rate; and
applying, by the RAN, the QoS profile to the session.

2. The method of claim 1, wherein the graded QoS profile is received from a policy control function (PCF) via one or more of an access and mobility management function (AMF) or a session management function (SMF).

3. The method of claim 1, wherein the set of QoS profiles are to be enforced in the RAN based on flow data rates observed in the RAN.

4. The method of claim 1, wherein the corresponding observed flow data rates are associated with one or more of uplink data rates or downlink data rates.

5. The method of claim 1, wherein the corresponding observed flow data rates include one or more of specific flow data rates or ranges of flow data rates.

6. The method of claim 1, wherein the graded QoS profile is received during a session management establishment procedure.

7. The method of claim 1, further comprising:
transmitting, by the RAN and to a policy control function (PCF), an indication of the QoS profile applied to the session.

8. A device, comprising:
one or more processors configured to:
receive a graded quality of service (QoS) profile indicating a set of QoS profiles and corresponding observed flow data rates;
measure an observed flow data rate of traffic associated with a session;
select a QoS profile from the set of QoS profiles based on the observed flow data rate; and
apply the QoS profile to the session.

9. The device of claim 8, wherein the graded QoS profile is received from a policy control function (PCF) via one or more of an access and mobility management function (AMF) or a session management function (SMF).

10. The device of claim 8, wherein the set of QoS profiles are to be enforced in a radio access network (RAN) based on flow data rates observed in the RAN.

11. The device of claim 8, wherein the corresponding observed flow data rates are associated with one or more of uplink data rates or downlink data rates.

12. The device of claim 8, wherein the corresponding observed flow data rates include one or more of specific flow data rates or ranges of flow data rates.

13. The device of claim 8, wherein the graded QoS profile is received during a session management establishment procedure.

14. The device of claim 8, wherein the one or more processors are further configured to:
transmit, to a policy control function (PCF), an indication of the QoS profile applied to the session.

15. The device of claim 8, wherein the device is associated with a radio access network (RAN).

16. A non-transitory computer-readable medium storing a set of instructions, the set of instructions comprising:
one or more instructions that, when executed by one or more processors of a device, cause the device to:
receive a graded quality of service (QoS) profile indicating a set of QoS profiles and corresponding observed flow data rates;
measure an observed flow data rate of traffic associated with a session;
select a QoS profile from the set of QoS profiles based on the observed flow data rate; and
apply the QoS profile to the session.

17. The non-transitory computer-readable medium of claim 16, wherein the graded QoS profile is received from a policy control function (PCF) via one or more of an access and mobility management function (AMF) or a session management function (SMF), and the graded QoS profile is received during a session management establishment procedure.

18. The non-transitory computer-readable medium of claim 16, wherein the set of QoS profiles are to be enforced in a radio access network (RAN) based on flow data rates observed in the RAN.

19. The non-transitory computer-readable medium of claim 16, wherein:
the corresponding observed flow data rates are associated with one or more of uplink data rates or downlink data rates; and
the corresponding observed flow data rates include one or more of specific flow data rates or ranges of flow data rates.

20. The non-transitory computer-readable medium of claim 16, wherein the one or more instructions, when executed by the one or more processors, further cause the device to:
transmit, to a policy control function (PCF), an indication of the QoS profile applied to the session.
